(19) United States
(12) Patent Application Publication
(10) Pub. No.: US 2024/0140652 A1
(43) Pub. Date: May 2, 2024

(54) Processing method of a tube head structure and a product thereof

(71) Applicant: Chih-Jung Chiang, Fujian (CN)

(72) Inventor: Chih-Jung Chiang, Fujian (CN)

(21) Appl. No.: 18/385,913

(22) Filed: Nov. 1, 2023

(30) Foreign Application Priority Data
Nov. 2, 2022 (CN) 202211363026.3

(51) Int. Cl. B65D 35/10; B29C 45/14; B29C 45/26; B65D 35/16

(52) U.S. Cl. CPC B65D 35/10; B29C 45/1418; B29C 45/261; B65D 35/16; B29L 2023/20

(57) ABSTRACT

A processing method of a tube head structure and a product thereof, specifically suitable for tube body made of special materials. The present invention improves a connecting method between the tube head and the tube body such that the two are more firmly connected. The processing method includes the following steps: A tube body sleeves a core rod; an upper mold is pressed to the core rod; when the upper mold is pressed downward, an upper end of the tube body is pressed and bends inwardly; after the upper mold finishes the downward pressing process, a tube head shaped cavity is formed between the upper mold, the tube body and the core rod, and a tip of the upper end of the tube body is not in contact with an opposite surface of the upper mold and an opposite surface of the core rod; injection molding material of the tube head is injected into the tube head shaped cavity, and the mold is opened after the injection molding material cools down and solidifies, thereby completing the injection molding. A tube head structure, including a tube body, and a tube head formed on the upper end of the tube body by overmolding; a shoulder position of the tube head protrudes to form an outer wrapping edge and an inner wrapping edge; the outer wrapping edge is positioned above the inner wrapping edge and the two are spaced apart by a gap; the upper end of the tube body bends inwardly; the outer wrapping edge and the inner wrapping edge are adhered to an outer surface and an inner surface of the upper end of the tube body by overmolding.

### FIELD OF THE INVENTION

The invention relates to the technical field of processing method of tubes, in particular to a processing method of a tube head structure and a product thereof.

### BACKGROUND OF THE INVENTION

The existing processing method of the tube head of the tube usually adopts high-frequency welding, wherein a tube body 1′ and a tube head 2′ are pre-formed separately; the tube body 1′ is first set on a core rod of a forming equipment, and then the tube head 2′ is placed on a shoulder position of the core rod and located at an inner upper end of the tube body 1′; a shoulder portion of the tube head 2′ and the inner upper end of the tube body 1 are heated by a welding mechanism of the forming equipment and the core rod to achieve connection, followed by cooling and demolding to obtain a finished tube as shown in FIG. 1.

In the above tube head processing method, the tube head and the tube body are made of materials with similar physical properties (e.g. plastic), such that the tube head and the tube body may be more firmly welded together at their welding joint. However, as technologies develop in the industry and product requirement keeps changing, a variety of materials, for example, environmentally-friendly paper, may now be used to make the tube body in order to be eco-friendly. Plastic films or aluminum foils are adhered to the surface of the tube body made of environmentally-friendly paper to improve corrosion resistance and impermeability of the tube body, such that the tube may be used to hold contents with strong odor or high permeability and corrosiveness, such as cosmetics and toothpaste. However, new problems will arise. The tube body is cylindrical when formed but is welded to the shoulder portion of the tube head, therefore inevitably causing wrinkles on the environmentally-friendly paper and the films or aluminum foils attached to its surface; due to the significant difference in physical properties between the tube head and the tube body, the connecting strength after welding is low. These problems affect the appearance of the tube, and more importantly, when the tube is squeezed during use, the welding joint between the tube head and the tube body easily detaches, resulting in potential danger of leakage and penetration, which then result in poor user's experience and a relatively short service life of the tube.

### BRIEF SUMMARY OF THE INVENTION

This invention provides a processing method of a tube head structure and a product thereof, wherein the tube head and the tube body are connected more firmly with a simpler processing method and a lower production cost. The present invention is particular suitable for tubes made of special materials.

This invention adopts the following technical solution:

A processing method of a tube head structure, comprising the following steps:
Step 1, a tube body sleeves a core rod;
Step 2, an upper mold is pressed downward towards the core rod; when the upper mold is pressed downward, an upper end of the tube body is pressed and bends inwardly; after the upper mold finishes its downward pressing process, a tube head shaped cavity is formed between the upper mold, the tube body and the core rod; and a tip of the upper end of the tube body is not in contact with an opposite surface of the upper mold and an opposite surface of the core rod;
Step 3, injection molding material of a tube head is injected into the tube head shaped cavity, and the upper mold is opened after the injection molding material cools down and solidifies, thereby completing the injection molding of the tube head.

In step 1, a shoulder position of the core rod is circumferentially provided with a recessed slot; when viewing in a cross-sectional manner, the recessed slot comprises a step provided on a peripheral surface of the core rod, a cut-away portion formed at an upper shoulder position of the core rod, and an arc-shaped surface connecting the step and the cut-away portion.

In step 2, a first arcuate surface and a second arcuate surface is formed in an inner surface of a shoulder position of the upper mold; a lower edge of the first arcuate surface is connected to an upper edge of the second arcuate surface; when the upper mold is pressed downward, the upper end of the tube body is in contact with the second arcuate surface and moves on the second arcuate surface, such that the upper end of the tube body bends inwardly and a gap is created between the tip of the upper end of the tube body and the first arcuate surface; the injection molding material of the tube head is then injected into the gap between the tip of the upper end of the tube body and the first arcuate surface in step 3.

In step 1, a shaft is inserted into a top surface of the core rod; the shaft is located at a center line of the tube head shaped cavity, and is used to form a through hole on the tube head.

An upper end and a lower end of the shaft are respectively embedded in the upper mold and the core rod after the upper mold has finished its pressing process downwardly towards the core rod.

The present invention also provides another technical solution:

A tube structure, comprising a tube body, and a tube head formed on an upper end of the tube body by overmolding; a shoulder position of the tube head protrudes to form an outer wrapping edge and an inner wrapping edge; the outer wrapping edge is positioned above the inner wrapping edge; the outer wrapping edge and the inner wrapping edge are spaced apart by a gap; the upper end of the tube body bends inwardly; the outer wrapping edge and the inner wrapping edge are adhered to an outer surface and an inner surface of the upper end of the tube body respectively by overmolding.

An annular protrusion is provided on an inner surface of the shoulder position of the tube head, and the inner wrapping edge extends from a lower edge of the annular protrusion.

The tube body comprises a tube made of environmentally-friendly paper, and also comprises an inner protective layer and an outer protective layer respectively attached to an inner surface and an outer surface of the tube.

Each of the inner protection layer and the outer protection layer comprises at least one layer of plastic film or aluminum foil.

An outer periphery of the tube head is provided with external threads, ridges, or straight tracks.

A top surface of the tube head is provided with at least one through hole.

The benefits of the above technical solutions are:

This invention allows the tube head to be directly formed at the upper end of the tube body 1 through overmolding. In the existing processing method, the tube head is formed separately and then welded to the tube body, yet the processing method of this invention is simpler with fewer steps. Only one set of upper mold and core rod is required, hence the production cost is lower.

When the upper mold closes against the core rod, the upper mold presses the upper end of the tube body and causes the upper end of the tube body to bend inwardly; the tip of the upper end of the tube body is neither in contact with the opposite surface of the upper mold nor the opposite surface of the core rod, and a space is reserved for the injection molding material of the tube head. After injection molding, the shoulder position of the tube head wraps the inner surface and the outer surface of the upper end of the tube body, and the injection molding material will be fully filled in the wrinkles of the tube body formed due to bending of the upper end of the tube body. The contact area between the tube head and the tube body 1 is larger, and the connection is stronger. This processing method is especially suitable for tubes wherein the tube body 1 is made of special materials.

### BRIEF DESCRIPTION OF THE DRAWINGS

FIG. 1 is a structural view of the tube head and the tube body connected with each other in the prior art.

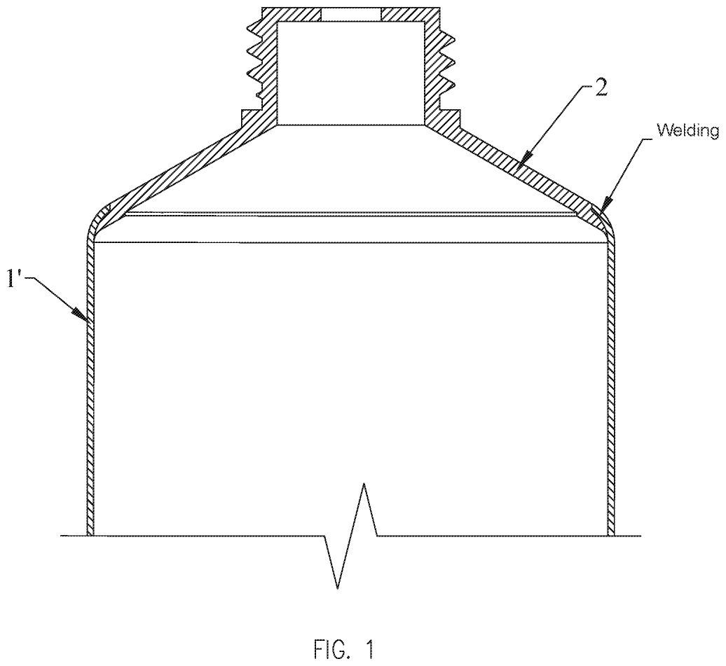

FIG. 2 is a structural view of the tube body sleeving the core rod according to a specific processing method of this invention.

FIG. 3 is a schematic view of pressing down an upper mold according to the processing method in the specific embodiment of this invention.

FIG. 4 is a structural view after the upper mold has finished its pressing process downwardly towards the core rod according to the processing method in the specific embodiment of this invention.

FIG. 5 is an enlarged view of portion A in FIG. 4.

FIG. 6 is a schematic view of overmolding according to the processing method in the specific embodiment of this invention.

FIG. 7 is a structural view of the tube in a specific embodiment of this invention.

FIG. 8 is an exploded view of the tube in the specific embodiment of this invention.

FIG. 9 is a cross-sectional view of the tube head assembled to the tube body in the specific embodiment of this invention.

FIG. 10 is an enlarged view of portion B in FIG. 9.

FIG. 11 is an exploded cross-sectional view of the tube head and the tube body in the specific embodiment of this invention.

### DETAILED DESCRIPTION OF THE INVENTION

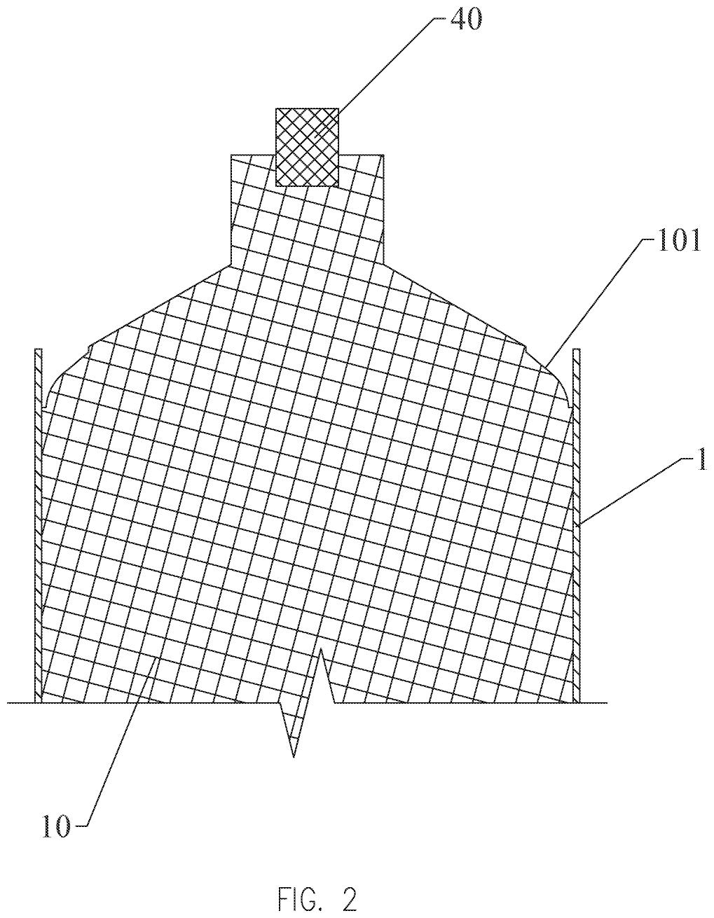

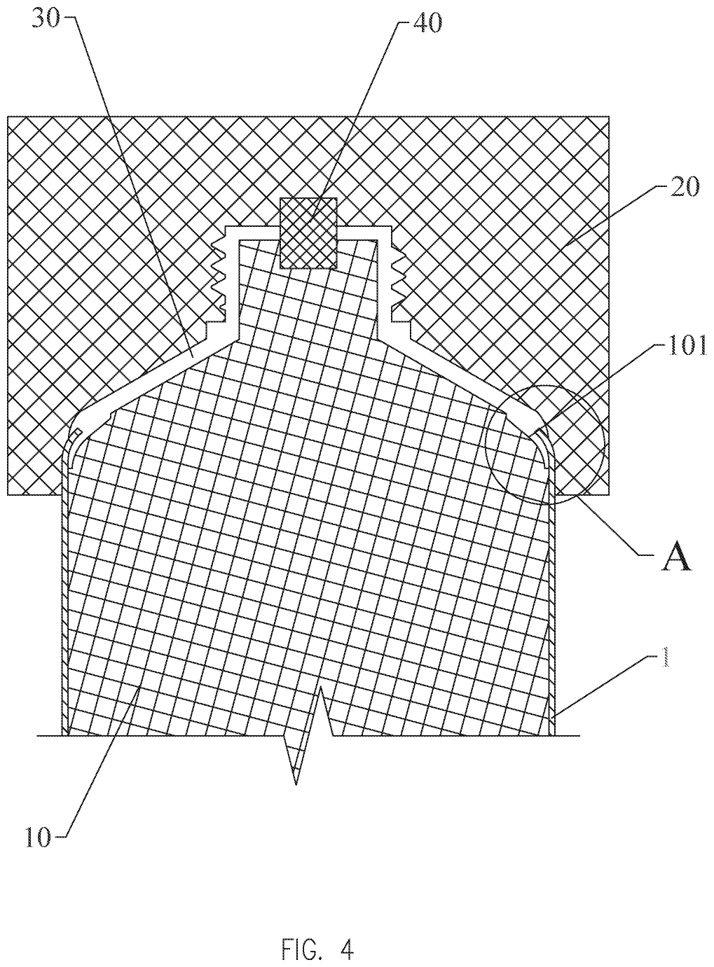

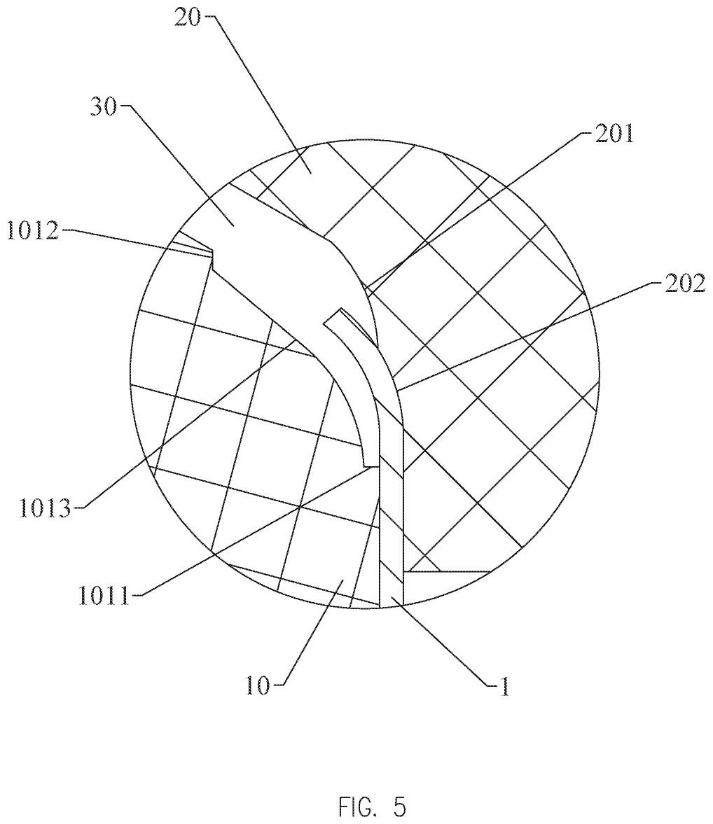

As shown in FIG. 2 to FIG. 6, a processing method of a tube head structure, comprising the following steps:

Step 1, as shown in FIG. 2, a tube body 1 sleeves a core rod 10;

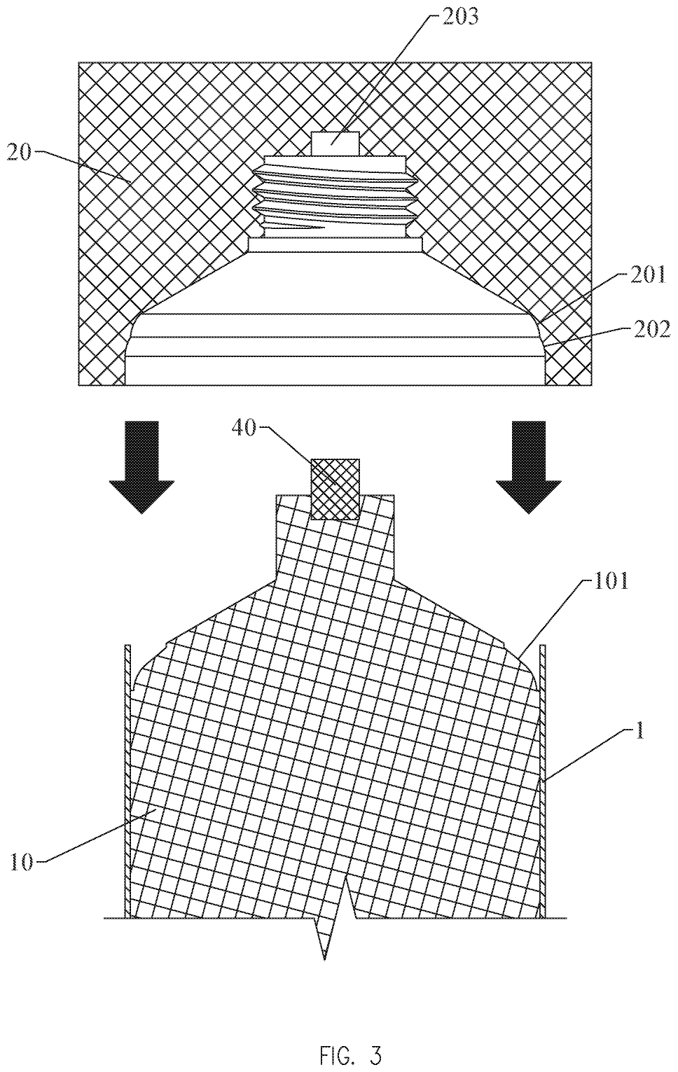

Step 2, as shown in FIG. 3 to FIG. 5, an upper mold 20 is pressed downward towards the core rod 10; when the upper mold 20 is pressed downward, an upper end of the tube body 1 is pressed and bends inwardly; after the upper mold 20 finishes its downward pressing process, a tube head shaped cavity 30 is formed between the upper mold 20, the tube body 1 and the core rod 10; and a tip of the upper end of the tube body 1 is not in contact with an opposite surface of the upper mold 20 and an opposite surface of the core rod 10;

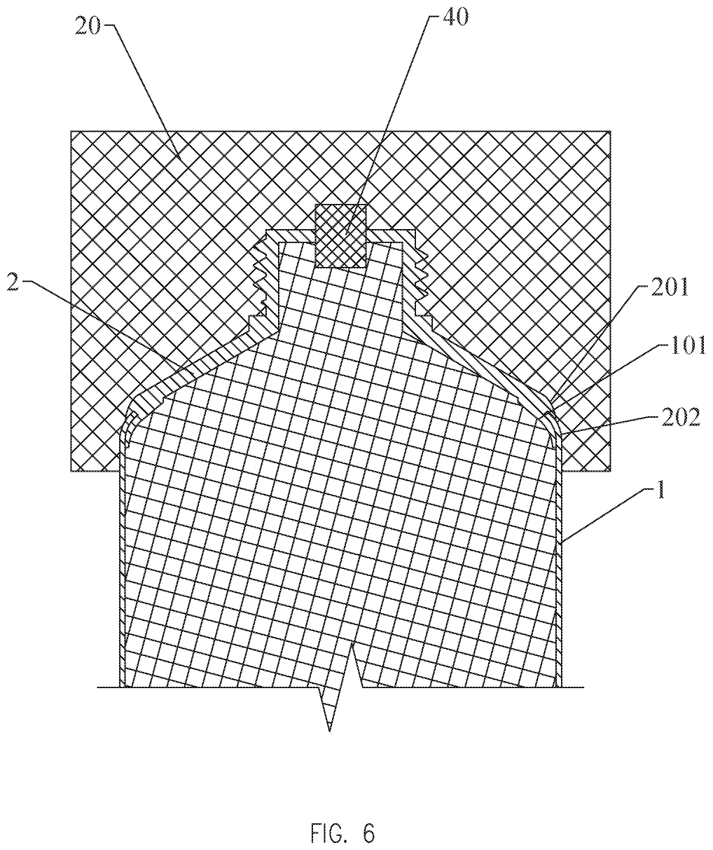

Step 3, as shown in FIG. 6, injection molding material of a tube head 2 is injected into the tube head shaped cavity 30, and the upper mold is opened (which means the upper mold 20 rises and detaches from the tube head 2) after the injection molding material cools down and solidifies, thereby completing the injection molding of the tube head 2.

A specific embodiment of the processing method in this invention is described as follows:

In the above step 1, a shoulder position of the core rod 10 is circumferentially provided with a recessed slot 101; when viewing in a cross-sectional manner, the recessed slot 101 comprises a step 1011 provided on a peripheral surface of the core rod 10, a cut-away portion 1012 formed at an upper shoulder position of the core rod 10, and an arc-shaped surface 1013 connecting the step 1011 and the cut-away portion 1012. The recessed slot 101 is positioned corresponding to the upper end of the tube body 1, such that the upper end of the tube body 1 is not in contact with the shoulder position of the core rod 10 after the tube body 1 is bent in step 2, and enough space is reserved for injection of the injection molding material of the tube head 2 in step 3.

In step 2, a first arcuate surface 201 and a second arcuate surface 202 is formed in an inner surface of a shoulder position of the upper mold 20; a lower edge of the first arcuate surface 201 is connected to an upper edge of the second arcuate surface 202; when the upper mold 20 is pressed downward, the upper end of the tube body 1 is in contact with the second arcuate surface 202 and moves on the second arcuate surface 202, such that the upper end of the tube body 1 bends inwardly and a gap is created between the tip of the upper end of the tube body 1 and the first arcuate surface 201; the injection molding material of the tube head 2 is then injected into the gap between the tip of the upper end of the tube body 1 and the first arcuate surface 201 in step 3. The first arcuate surface 201 has a concave shape which increases a distance between the upper mold 20 and the upper end of the tube body 1; therefore, the tip of the upper end of the tube body 1 is not in contact with the shoulder position of the upper mold 20 after bending, and there are enough space to allow the injection molding material of the tube head 2 to be injected in step 3.

In the above step 1, a shaft 40 is inserted into a top surface of the core rod 10; the shaft 40 is located at a center line of the tube head shaped cavity 30, and is used to form a through hole on the tube head.

Furthermore, in step 2 after the upper mold 20 finishes its downward pressing process, an upper end and a lower end of the shaft 40 are respectively embedded in the upper mold 20 and the core rod 10 to realize airtight connection; during injection molding, the injection molding material of the tube head 2 will not easily flow into a gap between the upper mold 20 and the shaft 40, hence reduces flashes and improves the quality of the demolded product; the shaft 40 also ensures that the core rod 10 and the upper mold 20 are coaxial. A slot 203 in which the core rod 40 is inserted is also provided at a center line of the upper mold 20.

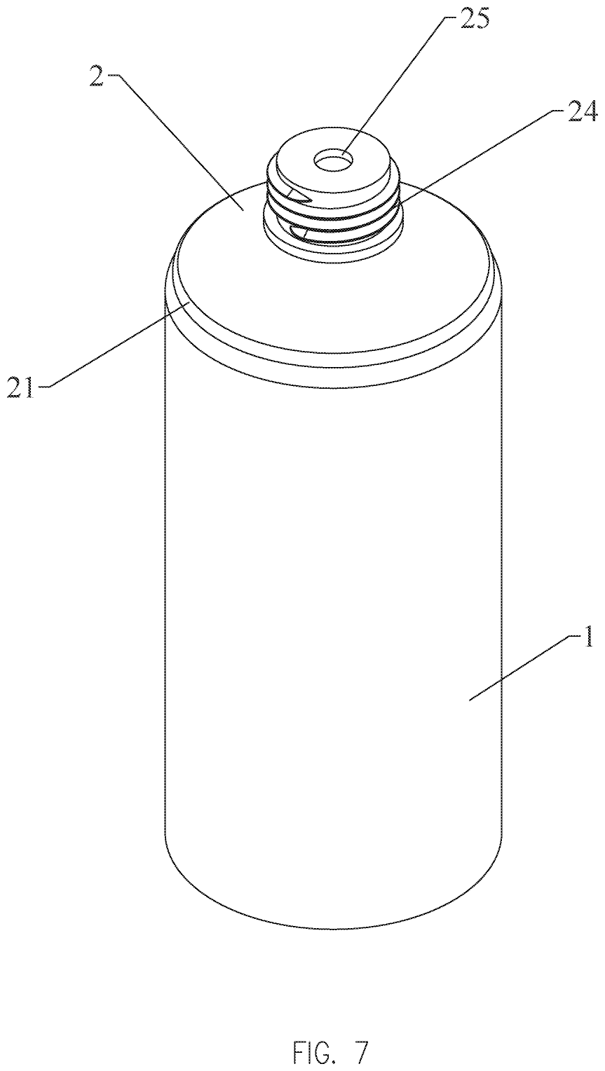

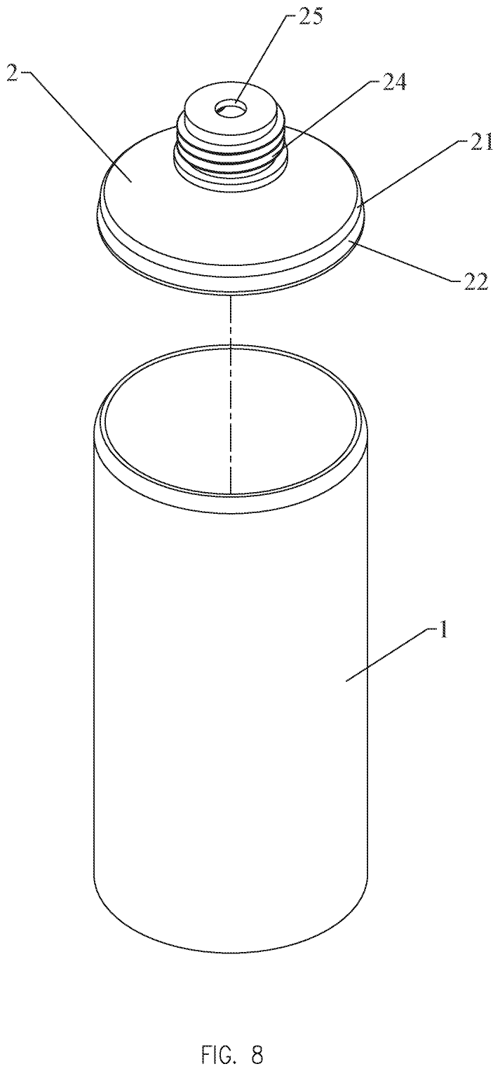

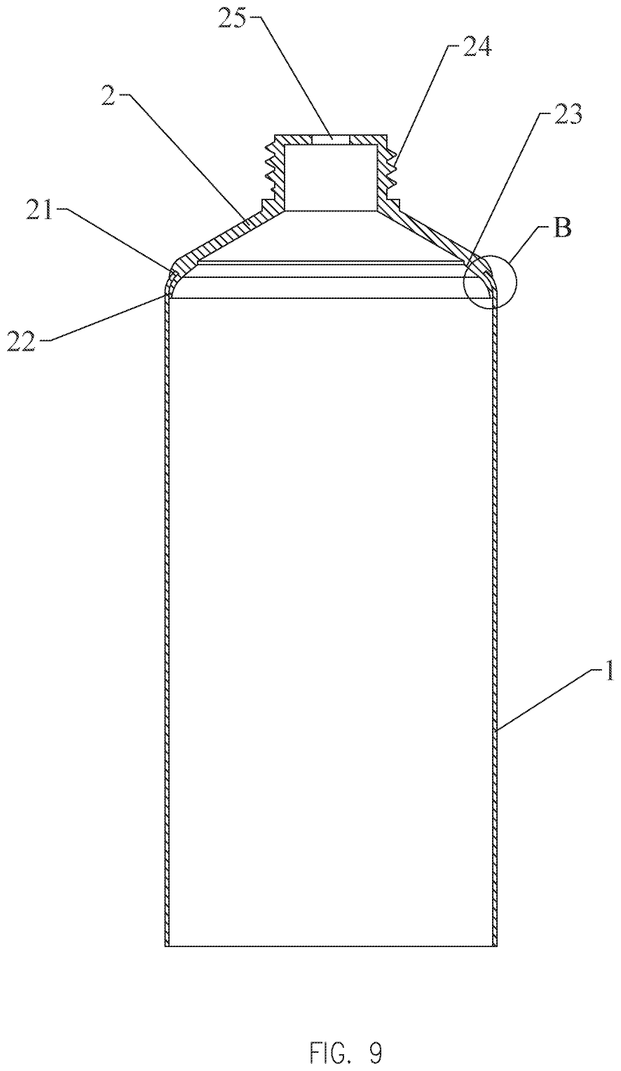

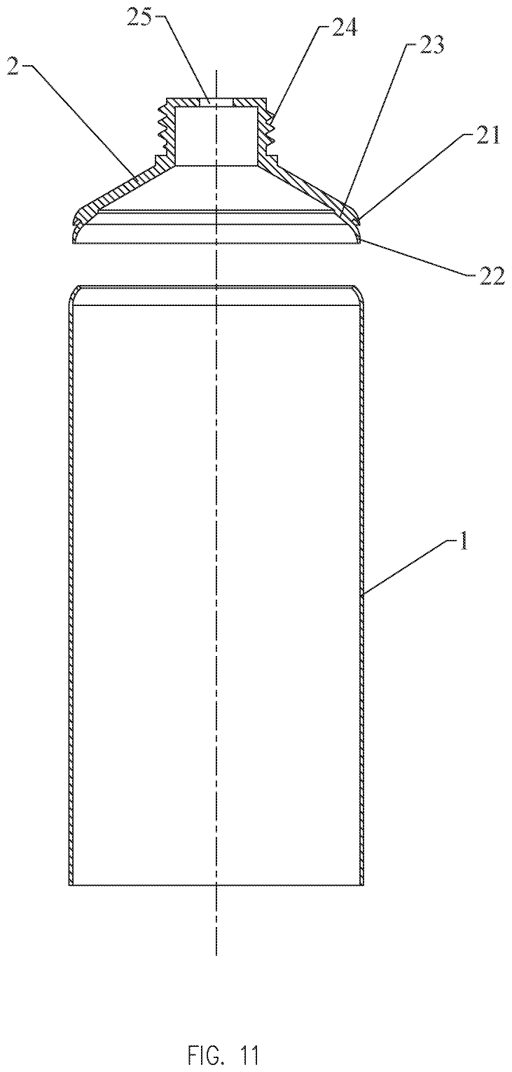

As shown in FIG. 7 to FIG. 11, a tube head structure, comprising a tube body 1, and a tube head 2 formed on an upper end of the tube body 1 by overmolding;

A shoulder position of the tube head 2 protrudes to form an outer wrapping edge 21 and an inner wrapping edge 22; the outer wrapping edge 21 is positioned above the inner wrapping edge 22; the outer wrapping edge 21 and the inner wrapping edge 22 are spaced apart by a gap; the upper end of the tube body 1 bends inwardly; the outer wrapping edge 21 and the inner wrapping edge 22 are adhered to an outer surface and an inner surface of the upper end of the tube body 1 respectively by overmolding.

A specific embodiment of the tube head structure is illustrated as follows:

An annular protrusion 23 (corresponding to the recessed slot 101 in the aforementioned method) is provided on an inner surface of the shoulder position of the tube head 2, and the inner wrapping edge 22 extends from a lower edge of the annular protrusion 23. The annular protrusion 23 increases a thickness of the shoulder position of the tube head 2, such that the inner wrapping edge 22 adhering to the inner surface of the upper end of tube body 1 and a connecting joint between the inner wrapping edge 22 and the inner surface of the upper end of the tube body 1 have sufficient thickness and strength, thereby improving the adhesive strength between the inner wrapping edge 22 and the tube body 1.

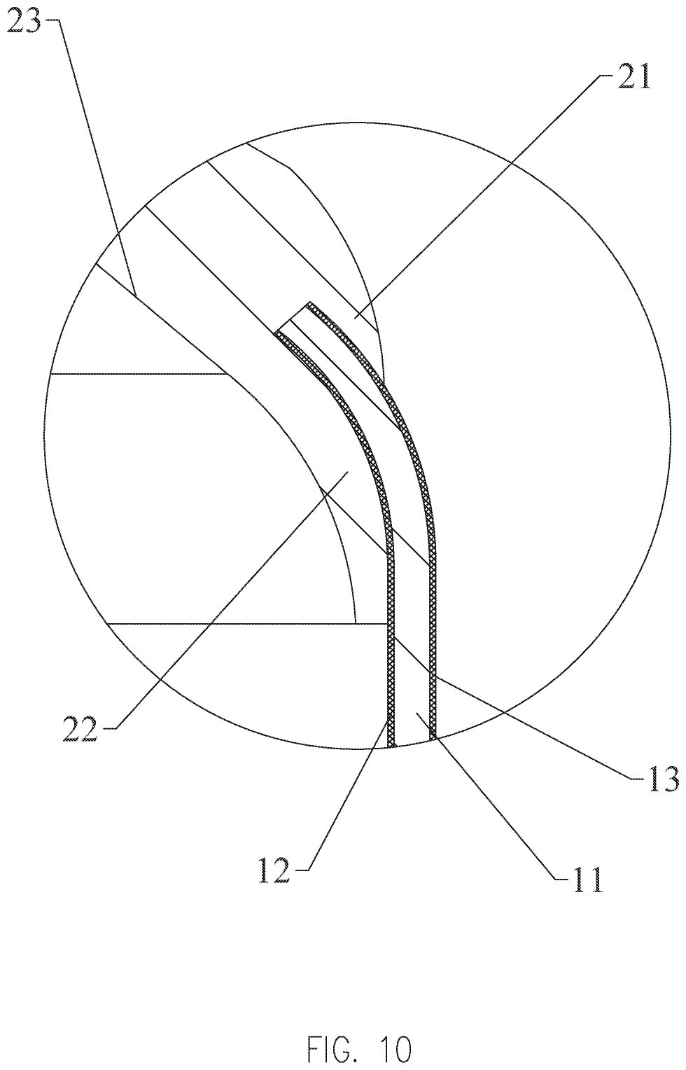

As shown in FIG. 10, the tube body 1 comprises a tube 11 made of environmentally-friendly paper, and also comprises an inner protective layer 12 and an outer protective layer 13 respectively attached to an inner surface and an outer surface of the tube 11.

Each of the inner protection layer 12 and the outer protection layer 13 comprises at least one layer of plastic film or aluminum foil.

An outer periphery of the tube head 2 is provided with external threads 24 or structures such as ridges or straight tracks, by which a cover of the tube may be fit in a threaded or press-fit manner.

A top surface of the tube head 2 is provided with at least one through hole 25 which allows contents in the tube to be squeezed out. The number and size of the through hole 25 may be customized according to different usage requirements.

This invention allows the tube head 2 to be directly formed at the upper end of the tube body 1 through overmolding. In the existing processing method, the tube head is formed separately and then welded to the tube body, yet the processing method of this invention is simpler with fewer steps. Only one set of upper mold 20 and core rod 10 is required, hence the production cost is lower. When the upper mold 20 closes against the core rod 10, the upper mold 20 presses the upper end of the tube body 1 and causes the upper end of the tube body 1 to bend inwardly; the tip of the upper end of the tube body 1 is neither in contact with the opposite surface of the upper mold 20 nor the opposite surface of the core rod 10, and a space is reserved for the injection molding material of the tube head 2. After injection molding, the shoulder position of the tube head 2 wraps the inner surface and the outer surface of the upper end of the tube body 1, and the injection molding material will be fully filled in the wrinkles of the tube body 1 formed due to bending of the upper end of the tube body 1. The contact area between the tube head 2 and the tube body 1 is larger, and the connection is stronger. This processing method is especially suitable for tubes wherein the tube body 1 is made of special materials (such as environmentally-friendly paper).

What is claimed is:

1. A processing method of a tube head structure, comprising the following steps:
Step 1, a tube body sleeves a core rod;
Step 2, an upper mold is pressed downward towards the core rod; when the upper mold is pressed downward, an upper end of the tube body is pressed and bends inwardly; after the upper mold finishes its downward pressing process, a tube head shaped cavity is formed between the upper mold, the tube body and the core rod; and a tip of the upper end of the tube body is not in contact with an opposite surface of the upper mold and an opposite surface of the core rod;
Step 3, injection molding material of a tube head is injected into the tube head shaped cavity, and the upper mold is opened after the injection molding material cools down and solidifies, thereby completing the injection molding of the tube head.

2. The processing method of claim 1, wherein in step 1, a shoulder position of the core rod is circumferentially provided with a recessed slot; when viewing in a cross-sectional manner, the recessed slot comprises a step provided on a peripheral surface of the core rod, a cut-away portion formed at an upper shoulder position of the core rod, and an arc-shaped surface connecting the step and the cut-away portion.

3. The processing method of claim 1, wherein in step 2, a first arcuate surface and a second arcuate surface is formed in an inner surface of a shoulder position of the upper mold; a lower edge of the first arcuate surface is connected to an upper edge of the second arcuate surface; when the upper mold is pressed downward, the upper end of the tube body is in contact with the second arcuate surface and moves on the second arcuate surface, such that the upper end of the tube body bends inwardly and a gap is created between the tip of the upper end of the tube body and the first arcuate surface; the injection molding material of the tube head is then injected into the gap between the tip of the upper end of the tube body and the first arcuate surface in step 3.

4. The processing method of claim 1, wherein in step 1, a shaft is inserted into a top surface of the core rod; the shaft is located at a center line of the tube head shaped cavity, and is used to form a through hole on the tube head.

5. The processing method of claim 4, wherein an upper end and a lower end of the shaft are respectively embedded in the upper mold and the core rod after the upper mold has finished its pressing process downwardly towards the core rod.

6. A tube head structure, comprising a tube body, and a tube head formed on an upper end of the tube body by overmolding; a shoulder position of the tube head protrudes to form an outer wrapping edge and an inner wrapping edge; the outer wrapping edge is positioned above the inner wrapping edge; the outer wrapping edge and the inner wrapping edge are spaced apart by a gap; the upper end of the tube body bends inwardly; the outer wrapping edge and the inner wrapping edge are adhered to an outer surface and an inner surface of the upper end of the tube body respectively by overmolding.

7. The tube head structure of claim 6, wherein an annular protrusion is provided on an inner surface of the shoulder position of the tube head, and the inner wrapping edge extends from a lower edge of the annular protrusion.

8. The tube head structure of claim 6, wherein the tube body comprises a tube made of environmentally-friendly paper, and also comprises an inner protective layer and an outer protective layer respectively attached to an inner surface and an outer surface of the tube.

9. The tube head structure of claim 8, wherein each of the inner protection layer and the outer protection layer comprises at least one layer of plastic film or aluminum foil.

10. The tube head structure of claim 6, wherein an outer periphery of the tube head is provided with external threads, ridges, or straight tracks.

11. The tube head structure of claim 6, wherein a top surface of the tube head is provided with at least one through hole.
